(19) United States
(12) Patent Application Publication
(10) Pub. No.: US 2006/0217111 A1
(43) Pub. Date: Sep. 28, 2006

(54) Network for customer care and distribution of firmware and software updates

(76) Inventors: Sunil Marolia, Laguna Niguel, CA (US); Jeffrey Brunet, Richmond Hill (CA)

Correspondence Address: MCANDREWS HELD & MALLOY, LTD, 500 WEST MADISON STREET, SUITE 3400, CHICAGO, IL, 60661, US

(21) Appl. No.: 11/352,702

(22) Filed: Feb. 13, 2006

Related U.S. Application Data
(60) Provisional application No. 60/652,457, filed on Feb. 11, 2005.

(51) Int. Cl. H04M 3/00; B65G 47/00; H04Q 7/20

(52) U.S. Cl. 455/418; 455/422.1; 186/35

(57) ABSTRACT

A network for customer care and distribution of update packages to electronic devices makes it possible to efficiently manage and update firmware and software in devices. A provisioning server in the network employs provisioning means to update configuration, provision devices and manage devices. An electronic device capable of receiving these update packages comprises a update client that is capable of updating the device.

### RELATED APPLICATIONS

The present application makes reference to, claims priority to and claims benefit of U.S. Provisional Patent Application Ser. No. 60/652,457, Attorney Docket No. 101USMD111, filed Feb. 11, 2004, the complete subject matter of which is hereby incorporated herein by reference, in its entirety.

The present application also makes reference to PCT Application having publication number WO/02/41147 A1 and PCT Application No. PCT/US01/44034, entitled “SYSTEM AND METHOD FOR UPDATING AND DISTRIBUTING INFORMATION”, filed Nov. 19, 2001, and U.S. Provisional Patent Application Ser. No. 60/249,606, entitled “SYSTEM AND METHOD FOR UPDATING AND DISTRIBUTING INFORMATION”, filed Nov. 17, 2000, the complete subject matter of each of which is hereby incorporated herein by reference, in its entirety.

The present application also makes reference to U.S. Pat. No. 6,832,373, entitled “SYSTEM AND METHOD FOR UPDATING AND DISTRIBUTING INFORMATION” and that issued on Dec. 14, 2004, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. If firmware or firmware components are to be changed in electronic devices, it is often very tricky to update the firmware components. Particularly, any code of functions that is employed to update firmware or firmware components themselves may have to be changed or updated. Such code or functions, when upgraded, may not fit into the space available in the electronic device (FLASH or other storage). Changes to firmware or firmware components must be performed in a fault tolerant mode and fault tolerant code are not easy to implement.

Typically one device at a time will be updated. However, if an operator needs to update millions of phones, updating one device at a time could be slow. There is no easy way to conduct mass updates of millions of devices, such as mobile handsets.

Support for determining a set of mobile handsets that may be targets of updates is often lacking. There are currently no easy techniques by which a mass update might be conducted. In addition, determining if these mass updates worked is also not possible.

Customer care centers get numerous calls for support from customers. They have very few means to determine what is wrong with a device. The Customer Care Representative (CSR) often asks questions of a customer, but they do not get proper answers. Customers often do not know what is wrong with their device. Thus, configuration changes that can fix a problem cannot be easily determined. Again, firmware updates that can fix the problem cannot be identified.

The demands upon the customer care organizations of wireless service providers is growing at a rapidly increasing rate. This is due to a number of factors including, for example, the increasing need for support in maintaining the security of wireless devices. The growing use of data services and the fact that currently available terminals are feature-rich and allow access to wide range of content exposes the wireless user to an ever-increasing chance of compromise of the wireless device. Wireless handsets are increasingly complex, and the underlying software components are standardized and more well-known. In addition, many wireless devices support multiple means of wireless access such as, for example, Bluetooth, short message service (SMS), multimedia message service (MMS), wireless application protocol (WAP), etc. Attacks on wireless mobile devices are escalating, and include Internet-born phenomena such as, for example, spam, ad-ware, and spy-ware, which are migrating into the mobile space. System operators are increasingly viewed as being responsible for content control. Network operators are experiencing growing malicious content as data service use increases. There is an increasing expectation of social responsibility, and pressure from local governments. Consumers expect security-enabled devices. Service providers are concerned about potential brand impact and support costs. Larger, enterprise wireless services customers have growing concerns about future threats and the time needed to react. Corporate applications are moving to wireless devices, necessitating greater security to protect proprietary information.

A number of different threats exist including viruses, worms, Trojan horses, spyware, adware, dialers, remote access software, and hybrid threats that combine several of the above and which are becoming increasingly common. Viruses self-replicate and cause damage, but require some user action to be triggered (e.g. executable email attachment). Worms are a virus variant that infect without any user interaction. Trojans consist of malicious code that is hidden within innocuous code or data and can be distributed with viruses. Spyware and adware are programs that secretly gather information and relay it to other interested parties, while dialers establish connections without a user's permission. Hoaxes are usually an email or message sent in chain-letter fashion. Remote Access programs permit one computer to gain access and control over another.

The majority of these threats have impact upon system operators. First, there are the support costs. Carriers receive all support calls for any issues, including messaging and wireless handset. There is also the issue of revenue loss. Customers won't pay if service is interrupted. There is always the possibility of brand damage. By protecting against loss of subscribers, system operators protect top line revenue. In addition, by providing the support needed to provide adequate security, a system operator may enable increases in revenue through the sale of other paid data services and applications. A system operator may also offer security as a premium service to drive average revenue per user.

Wireless system operators also typically provide support for resolution of wireless handset and wireless network problems. The complexity and variety of new mobile devices, operating systems and data services has created a significant customer support burden for device manufacturers and wireless operators. In the past, most support calls from subscribers were related to billing, rate plans, or network coverage. Today, a large and growing number of calls to customer support are related to data, email and MMS settings, Internet connectivity, and mobile application usage. Often these calls require escalation from Tier 1 Customer Service Representatives (CSRs) to more expensive Tier 2 and Tier 3 technicians. Not only are calls becoming more technical in nature, but call volume and call length are increasing as well. On average, the call length for data-related support calls is three times that of voice calls, resulting in skyrocketing customer service costs for mobile operators. When changes to a given model of wireless handset are available for distribution, a given network operator may have hundreds or even hundreds of thousands of wireless handsets that contain incorrectly programmed parameters, or software bugs. Handling the remediation of these types of problems on such a scale is presently not well supported by existing operations systems.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method supporting customer care in a wireless communication network, substantially as shown in and/or described in connection with at least one of the figures, as set forth more completely in the claims.

These and other advantages and novel features of the present invention, as well as details of an illustrated embodiment thereof will be more fully understood from the following description and drawings.

### BRIEF DESCRIPTION OF SEVERAL VIEWS OF THE DRAWINGS

FIG. 1 shows a communication network supporting customer care for a subscriber mobile device in a wireless network of a wireless service provider, in which a representative embodiment of the present invention may be practiced.

FIG. 2 shows a block diagram of an exemplary wireless communication network with customer care server and customer service representative console (CSRC) supporting wireless service for a mobile device of a subscriber served by wireless service provider, in accordance with a representative embodiment of the present invention.

FIG. 3 illustrates additional detail of an exemplary device agent from a wireless mobile device that may correspond to, for example, the wireless mobile devices of FIGS. 1 and 2, in which the device agent provides support for customer care activities, in accordance with a representative embodiment of the present invention.

FIG. 4 shows a block diagram of an exemplary wireless communication network similar to that of FIG. 2, having a customer care server and customer service representative console (CSRC) that supports wireless service for a mobile device of a subscriber served by wireless service provider, that also supports remote wireless subscriber management of a mobile device, in accordance with a representative embodiment of the present invention.

FIG. 5 illustrates a display screen showing an exemplary web page that may be used in a self-care environment for a wireless service provider, in accordance with a representative embodiment of the present invention.

FIG. 6 illustrates a display screen showing an exemplary web page that may be displayed following entry of the subscriber directory number and activation of the “Submit” button on the web page of FIG. 5, in accordance with a representative embodiment of the present invention.

FIG. 7 shows a display screen containing an exemplary web page displaying device profile information such as that described above with respect to FIGS. 2, 3, and 4, following the retrieval of the device profile information from a subscriber mobile device such as, for example, the mobile device of FIGS. 2, 3, and 4, in accordance with a representative embodiment of the present invention.

FIG. 8 illustrates a display screen showing an exemplary web page with a message box that may be displayed to confirm a subscriber request to fix one of the problems shown in the analysis portion of FIG. 7, in accordance with a representative embodiment of the present invention.

FIG. 9 illustrates a display screen showing an exemplary web page comprising a message box that may be displayed to confirm the successful completion of an action such as that requested with respect to FIG. 8, in accordance with a representative embodiment of the present invention.

FIG. 10 shows a workflow diagram for an exemplary self-care client provisioning settings process for an electronic device such as, for example, the mobile device shown in FIGS. 2, 3 and 4, in accordance with a representative embodiment of the present invention.

FIG. 11 shows a work flow diagram for an exemplary self-care process of updating device management settings for a device such as, for example, the mobile device shown in FIGS. 2, 3 and 4, in accordance with a representative embodiment of the present invention.

FIG. 12 shows a flow diagram for an exemplary self-care process of performing new account registration for a device such as, for example, the mobile device shown in FIGS. 2, 3 and 4, in accordance with a representative embodiment of the present invention.

FIG. 13 is a perspective block diagram of a network for mass distribution of firmware and software updates that comprises a device management (DM) server, an electronic device and a provisioning server, in accordance with a representative embodiment o the present invention.

FIG. 14 is a flowchart of an exemplary method of providing customer care for a subscriber of a wireless communication network such as, for example, the wireless communication network of FIG. 4, in accordance with a representative embodiment of the present invention.

### DETAILED DESCRIPTION OF THE INVENTION

The present invention relates generally to the process of updating software/firmware in an electronic device and, more specifically, to the use of a network that supports customer care based management of mobile devices and firmware and software updates of multiple devices.

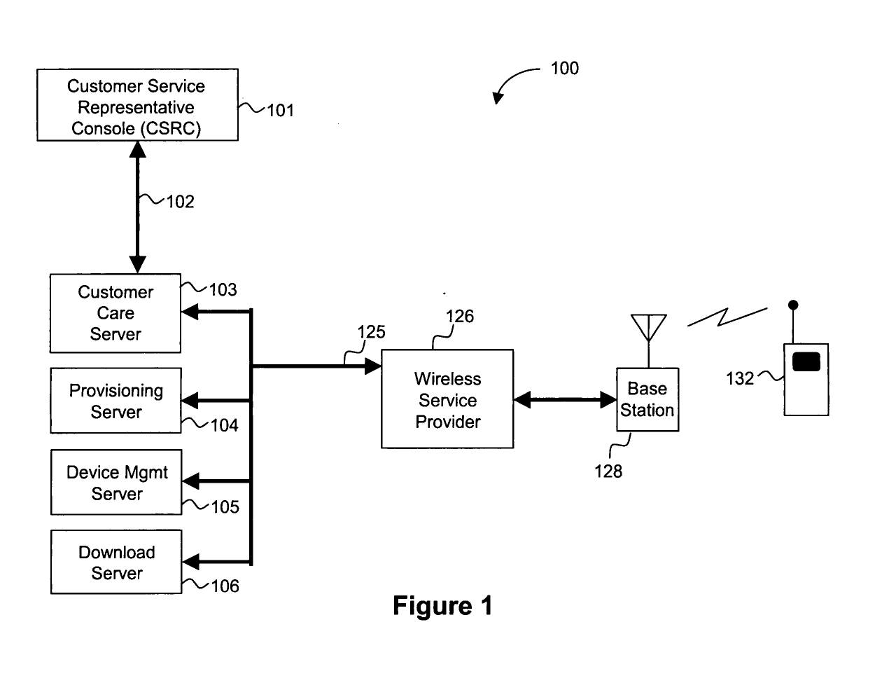

FIG. 1 shows a communication network 100 supporting customer care for a subscriber mobile device 132 in a wireless network of a wireless service provider 126, in which a representative embodiment of the present invention may be practiced. The communication network 100 comprises a customer service representative console (CSRC) 101 communicatively coupled to a customer care server 103 via a communication path 102. The CSRC 101 may comprise, for example, a dedicated terminal device, or a personal computer having application software supporting, for example, a web site interface provided by the customer care server 103. The communication path 102 may comprise a dedicated wired or wireless communication link. The communication path 102 may also comprise an intranet, the Internet, a wired or wireless local area network, a packet network, or any other suitable form of communication path.

The communication network 100 also comprises a provisioning server 104, that may also be referred to herein as a “broadcast server”, and a device management (DM) server 105 that may support, for example, an Open Mobile Alliance (OMA) device management (DM) protocol, or a proprietary protocol. The communication network 100 also comprises a download server 106 for downloading update packages to the mobile device 132. In a representative embodiment of the present invention, an update package may, among other things, comprise a set of instructions executable by an update agent (not shown) in the mobile device 132 to convert or transform an existing version of software and/or firmware code to an updated version.

As shown in the illustration of FIG. 1, the customer care server 103, the provisioning server 104, the DM server 105 and the download server 106 may be communicatively coupled via a communication path 125 to a wireless service provider 126 having at least one base station 128. The communication path 125 may comprise any of the communication links described above with respect to the communication path 102. Although only one base station is shown in FIG. 1, this does not represent a specific limitation of the present invention, as a greater number of base stations may be employed without departing from the scope of the present invention.

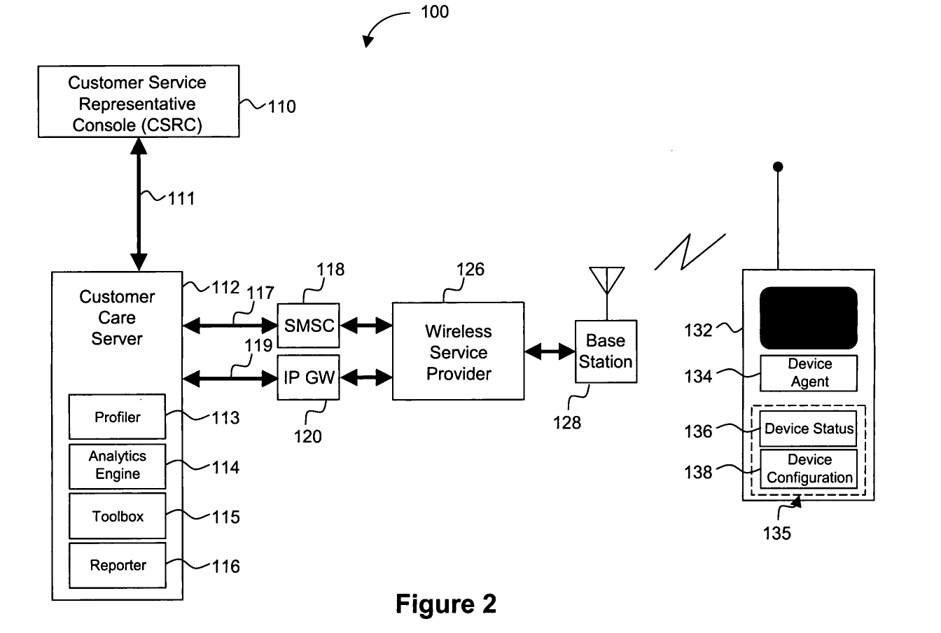

FIG. 2 shows a block diagram of an exemplary wireless communication network 100 with customer care server 112 and customer service representative console (CSRC) 110 supporting wireless service for a mobile device 132 of a subscriber served by wireless service provider 126, in accordance with a representative embodiment of the present invention. The wireless communication network 100 of FIG. 2 comprises the wireless service provider 126 communicatively coupled to a base station 128, via a wired or wireless connection. Although only one wireless base station 128 is shown in FIG. 2, this is for reasons of clarity and does not represent a specific limitation of the present invention. A greater number of wireless base stations 128 may be employed by the wireless service provider 126, depending upon coverage area and services supported, without departing from the scope of the present invention. The wireless base station 128 communicates with the mobile device 132 via any of a number of wireless communication standards including, for example, various forms of code division multiple access (CDMA) and time division multiple access (TDMA) wireless air interfaces. The mobile device 132 may comprise any of a variety of electronic devices including, for example, a cellular phone, a personal digital assistant, a pager, a personal computer, and a multimedia handset, to name only a few types of devices. Depending upon the interests of the subscriber and the capabilities of the wireless communication network 100, the wireless service provider 126 may provide one or both of voice and data services to the mobile device 132 via the wireless base station 128.

In a representative embodiment of the present invention, a mobile device such as, for example, the mobile device 132 of FIG. 2 may comprise a device profile information 135 including, for example, device status information 136 and device configuration information 138. Although FIG. 2 shows only device status information 136 and device configuration information 138, the device profile information 135 retrieved by the device agent 134 may include information on hundreds of device parameters, resident software and firmware applications that are loaded on the mobile device 132 and their versions, signal strengths, meter readings, parameter settings, network settings, and other information, for example. In some representative embodiments of the present invention, such device profile information 135 may reside within a device management tree (not shown) in the memory of the mobile device 132. The device management tree may be used as a means to enable storage of and access to various items of data and code in the mobile device 132. Further details of the use of a device management tree for the management of mobile device parameters and code may be found in U.S. patent application Ser. No. 10/868,050 entitled “Management Tree Management In A Mobile Handset” (Attorney Docket No. 15837US02), filed Jun. 16, 2004, the complete subject matter of which is hereby incorporated herein by reference, in its entirety.

The user of mobile device 132 may have questions about their wireless service, or experience difficulties with the operation of the mobile device 132, and may contact a Tier 1 customer support member such as the CSRC 110, to seek help. This contact may be initiated via the mobile device 132, or may be established via another communication path to the CSRC 110 such as, for example, a conventional wired telephone connection or voice-over-internet protocol (VoIP) connection. Upon receiving a call from the subscriber, the CSRC 110 may communicate with the customer care server 112 via a communication path 111 that may comprise, for example, a wireless or wired communication path such as a cellular wireless network, a conventional circuit switched network, a packet-switched network, a private intranet, a public Internet, or any combination of the above. In various representative embodiments of the present invention, the CSRC 110 may use, for example, a dedicated console in direct communication with the customer care server 112, or may use a web browser software application on a personal computer communicating via the Internet with the customer care server 112.

In a representative embodiment of the present invention, the customer care server 112 may comprise a profiler 113, an analytics engine 114, a toolbox 115, and a reporter 116. The profiler 113 may communicate with a device agent 134 in the mobile device 132 to gather device settings, software/firmware versions and status information. The profiler 113 may validate the processes involved, and may store the gathered information as a device profile on the customer care server 112. The analytics engine 114 may analyze the data gathered from the mobile device 132 by the profiler 113, may highlight any discrepancies, may engage external tools as needed, and may guide the customer service representative at the CSRC 110 through the process of trouble resolution. The toolbox 115 may permit a customer service representative to compare device profile information with standard templates to identify differences, and to view device and customer care history information. The toolbox 115 may permit the customer service representative to view modifications that have been applied to the mobile device 132 that are different from a standard configuration. The reporter 116 may capture all device profile information and troubleshooting data by logging all call processes. This may allow for detailed analysis and reporting of key metrics. Such metrics may be important in assisting a system operator to gauge average revenue per unit (ARPU) per mobile device, and actual contribution margin levels based upon support costs.

In a representative embodiment of the present invention, a customer care server such as, for example, the customer care server 112 may be capable of establishing communication with a device agent 134 resident in the mobile device 132. Communication between the customer care server 112 and the mobile device 132 may function using any of a variety of communications means including, for example, an Open Mobile Alliance (OMA) Device Management (DM) protocol as developed under the auspices of the Open Mobile Alliance, or the customer care server 112 and mobile device 135 may communicate using a proprietary protocol. The messaging used to exchange device profile information may be transported using a short message service (SMS) protocol, a multimedia messaging service (MMS) protocol, circuit switched data link, and/or a packet data link using a hypertext transport protocol (HTTP), to name only a few such mechanisms.

In one representative embodiment of the present invention, the customer care server 112 may communicate with the mobile device 135 using, for example, an SMS protocol via a communication path 117 to a short message service center (SMSC) 118. The SMSC 118 may exchange SMS messages with the mobile device 135 via wireless service provider 126 and base station 128. In another representative embodiment, the customer care center 112 may communicate with the mobile device 135 using, for example, HTTP messages via communication path 119 to an Internet Protocol (IP) gateway (GW) 120. The IP gateway 120 may exchange HTTP messages with the mobile device 135 via the same wireless service provider 126 and base station 128.

The analytics engine 114 of the customer care server 112 may function to analyze mobile device profile information such as, for example, the device status information 136 and device configuration information 138, that is retrieved by software on the customer care server 112 from the memory of the mobile device 132. The device agent 134 may function to enable remote access to the device profile information 135 (i.e., device status information 136 and device configuration information 138) by applications such as, for example, the profiler 113 in the customer care server 112. The device agent 134 may be embedded by the manufacturer, or can be downloaded to the mobile device 132 over the air at the request of the CSRC 110. By employing a representative embodiment of the present invention, the CSRC 110 gains full visibility into the mobile device 132 of the subscriber, and how it's currently configured.

In a representative embodiment of the present invention, the customer care server 112 may establish communication with the mobile device 132 to directly retrieve items of device profile information 135 such as, for example, the device configuration information 138 and device status information 136, depending upon actions requested by the CSRC 110. This approach gathers the needed items from the device profile information 135 (e.g., device status information 136 and device configuration information 138) directly from the mobile device 132, eliminating the need to quiz the subscriber and guide them through a tedious search through a series of menus on the mobile device 132. The customer care server 112 may provide privacy controls, allowing the CSRC 110 to confirm subscriber consent before the transfer of any device profile information from the mobile device 132 to the customer care server 112. Once the device profile information 135 has been receive by the customer care server 112, the retrieved device profile information 135 may be viewed by the CSRC 110. The CSRC 110 may add, delete and update multiple device settings from a single screen, and may compare current device configurations with standardized configurations. Differences from standard configurations may be highlighted, and the CSRC 110 may reset the device profile information 135 in the mobile device 132 dynamically. The CSRC 110 may define new configuration templates for a new mobile device using a forms-based interface.

In a representative embodiment of the present invention, the retrieved device profile information may be quickly analyzed by the analytics engine 114 to determine whether the information conforms to a set of “rules”. The analytics engine 114 may compare the device profile information 135 to a database of known problems, and may identify potential issues such as, for example, unexpected device parameters, outdated software/firmware versions, historical configuration discrepancies, and application conflicts, and may flag these conditions on the display of the CSRC 110. The rules used by the analytics engine 114 may be based upon, among other things, the type of mobile device, and the complement of services subscribed to by the subscriber. The rules engine may highlight known issues on-screen for the CSRC 110, and may suggest possible problem resolutions, which the CSRC 110 may execute in real-time. For example, the customer care server 112 may trigger the re-provisioning of the mobile device 132 with the correct settings (e.g. modify items in the device profile 135), or initiate a software/firmware update to fix known software/firmware bugs, or to install new capabilities and features such as, for example, an anti-virus agent (not shown), over-the-air (OTA). In various representative embodiments of the present invention, such updates of firmware and/or software may be performed by the customer care server 112, or by a separate device management server (not shown). For problems that require deeper technical assistance, the CSRC 110 may immediately transfer the full device profile information 135 and subscriber information to a Tier 2 or 3 analyst (not shown), saving time and reducing customer aggravation. Tier 2 and Tier 3 technicians may then use the received information to analyze the full details of subscriber device profile information such as the device profile information 135, for example, and its history. Once a problem is diagnosed and resolved, they can then create new rules for the analytics engine 114 of the customer care server 112, allowing the analytics engine 114 to automatically identify those problems when they occur in the future. A representative embodiment of the present invention makes information gathering, and problem escalation, diagnosis and resolution faster, easier and more accurate than prior solutions.

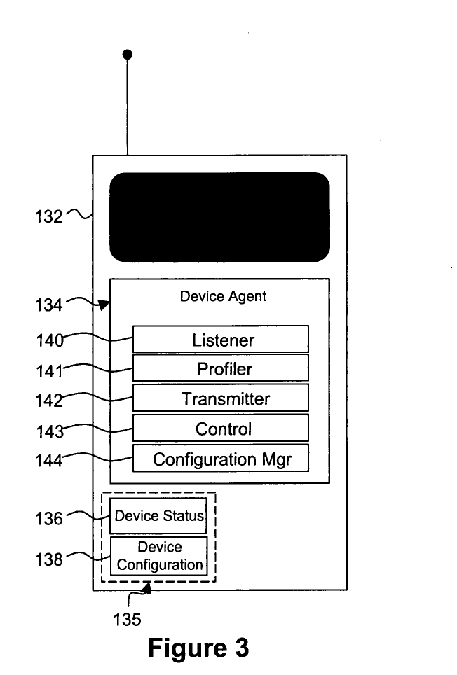

FIG. 3 illustrates additional detail of an exemplary device agent 134 from a wireless mobile device 132 that may correspond to, for example, the wireless mobile devices 132 of FIGS. 1 and 2, in which the device agent 134 provides support for customer care activities, in accordance with a representative embodiment of the present invention. As shown in FIG. 3, the device agent 134 comprises a listener function 140 that may also be referred to herein as a “device listener” or “listening client” for receiving short message service (SMS) or hypertext transport protocol (HTTP) messaging from a customer care or device management server, a profiler function 141 for cooperatively performing profile activities as described above, a transmitter function 142 for transmitting responses to, for example, a customer care server or device management server using SMS or HTTP messaging, a control functionality 143, and a configuration manager 144.

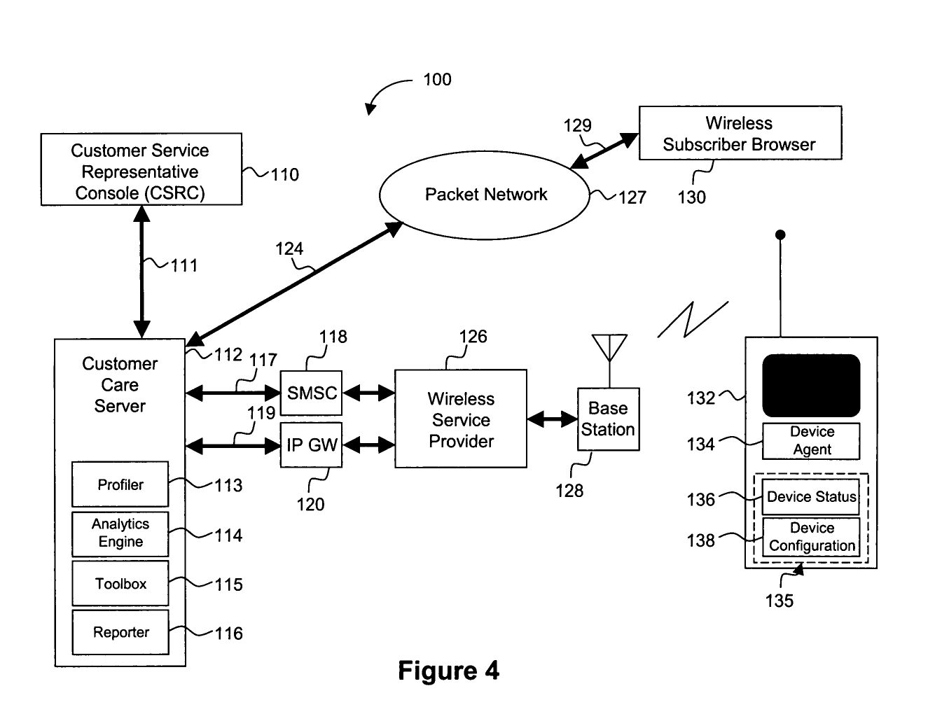

FIG. 4 shows a block diagram of an exemplary wireless communication network 100 similar to that of FIG. 2, having a customer care server 112 and customer service representative console (CSRC) 110 that supports wireless service for a mobile device 132 of a subscriber served by wireless service provider 126, that also supports remote wireless subscriber management of a mobile device 132, in accordance with a representative embodiment of the present invention. The elements of the wireless communication network 100 shown in FIG. 4 may correspond to, for example, those elements of FIG. 2 having the same reference numbers. The wireless communication network 100 of FIG. 4, however, comprises a communication path 124 to a packet network 127. The packet network 127 may comprise, for example, an intranet or Internet network, a virtual private network, a circuit switched network, a local area network, a wireless wide area or local area network, alone or in any combination. As shown in FIG. 4, the packet network 127 is connected via a communication path 129 to a browser application 130 of a subscriber of the wireless service provider 126, for example. The wireless subscriber browser 130 may operate on a personal computer, handheld web-capable device such as, for example, a wireless mobile device.

In a representative embodiment of the present invention, a wireless subscriber may perform many of the functions available to a customer service representative via the CSRC 110, without involving a customer service representative. For example, in one representative embodiment of the present invention, the subscriber may use a conventional web browser application, shown in FIG. 4 as the wireless subscriber web browser 130, to access the customer care server 112, and to cause the profiling, troubleshooting, provisioning, and enhancement of a wireless mobile device 135. Access to a self-care web portal may appear as a link on a home page of a wireless service provider such as the wireless service provider 126, for example. Self-care activities may be available to, for example, a subscriber at home using a wire line connection to the Internet, and to subscribers using a Bluetooth or WiFi connection to a kiosk at the wireless service provider's retail outlet. In this manner. the customer support representative normally seated in front of the CSRC 110, is replaced by wireless subscribers helping themselves from their homes, offices, and while away from the home/office, via the familiar functionality of a web-based browser interface. In another representative embodiment of the present invention, the customer may access a customer care server such as, for example, the customer care server 112 using an interactive voice response (IVR) system. Again, a direct interface between a subscriber and a customer care server such an that illustrated in FIG. 4 eliminates the need for interaction between the subscriber and a live customer representative, enables diagnostic and corrective actions, and reduces costs for the wireless service provider.

Based upon subscriber request, a representative embodiment of the present invention may conduct a profile of a mobile device such as the mobile device 132 of FIG. 4, for example, that is identical to that conducted via the CSRC 110 by a customer service representative. Details about the types of information contained in device profile information such as the device profile information 135 of FIG. 4, were described in greater detail above with respect to FIG. 2. A customer care server like the customer care server 112, for example, may support a web-base subscriber interface using the same rules engine (e.g., analytics engine 114) used by customer service representatives, to identify incorrectly configured settings, viruses, and usage parameters. At the discretion of the wireless service provider, some or all of the device profile information may be made available to the wireless subscriber. The form in which such information is presented over the web-based browser interface may be customizable, allowing the wireless service provider to present the information in a form appropriate to the subscriber base, and to restrict those pieces of information deemed unsuitable for access by the subscriber. The administrative controls on the customer care server may allow the service provider to enable some or all of the settings of items in the device profile information to be modified by the user.

In a representative embodiment of the present invention, all actions by the subscriber and the customer care server 112 and its component systems may be logged into a database (not shown). This database may be combined with or separate from databases used to support customer service representative activities, and may later be accessed on behalf of the subscriber, either by the subscriber, or in some instances, by a customer service representative via a customer service representative console such as the CSRC 110 of FIG. 4, for example. This may occur when a wireless subscriber experiences difficulty in solving a given mobile device or service problem, in accessing device profile information, or in making desired changes to a mobile device while using the web-based interface of the customer care server 112. In such a situation, the subscriber may contact a customer service representative for assistance. The customer service representative may then be allowed to access the combined or separate databases on behalf of the subscriber, and may be able to see actions taken by the subscriber, device profile information from the subscriber mobile device, determine the source of the difficulty, and rectify the problem.

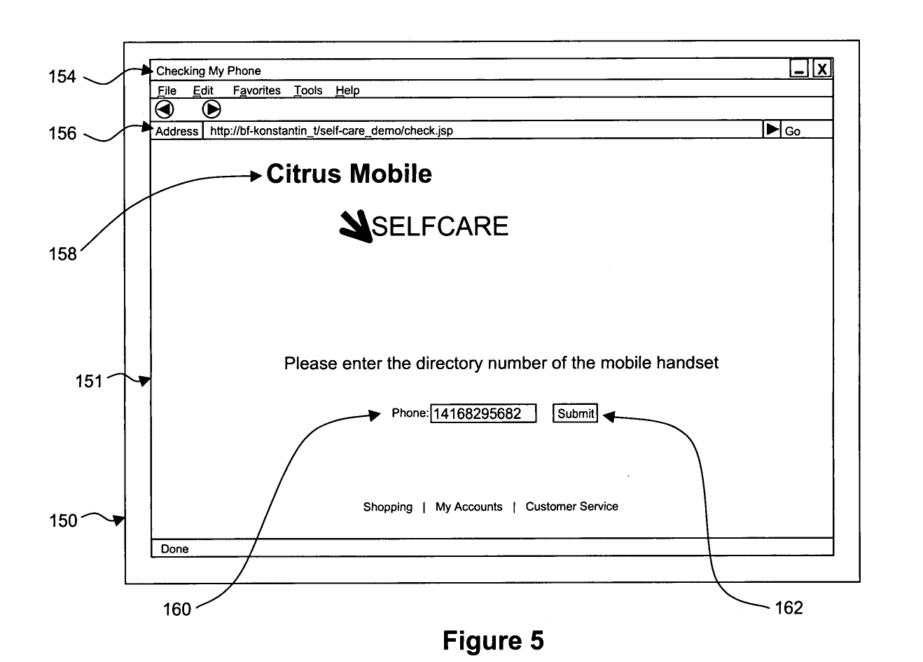

FIG. 5 illustrates a display screen 150 showing an exemplary web page 152 that may be used in a self-care environment for a wireless service provider, in accordance with a representative embodiment of the present invention. The web page 152 may be suitable for display by a web browser such as the wireless subscriber browser 135 of FIG. 4, for example. The wireless subscriber browser 135 may comprise, for example, the Internet Explorer web browser from Microsoft Corporation, or any other web browser. As illustrated in FIG. 5, the web page 152 comprises a page name 154 “Checking My Phone” that identifies the web page being viewed, and an Internet universal resource locator (URL) 156 that shows the location being accessed. In a representative embodiment of the present invention, the web page 152 may comprise a wireless service provider identity 158 to clearly show the owner of web page 152. The subscriber may enter the directory number of a mobile device such as, for example, the mobile device 132 of FIG. 4, for example, into the phone field 160, to identify the mobile device of interest. Although a directory number is shown as the identifying parameter in FIG. 5, alternative identifying parameters such as the electronic serial number (ESN), mobile station identifier (MSID), international mobile station identifier (IMSI) or another suitable mobile or subscriber associated identifier may be used. In this example, the user is requested to enter the directory number of the mobile handset. The user then enters the phone number of the cellular phone into the phone field 160, and sends the mobile identity to the customer care server 112 by clicking on the “Submit” button 162. Although not shown in FIG. 5, an additional prompt may request authorization/authentication information (e.g., a personal identification number (PIN), a piece of pre-arranged subscriber secret information, etc.), before access to any subscriber or mobile-specific information is permitted.

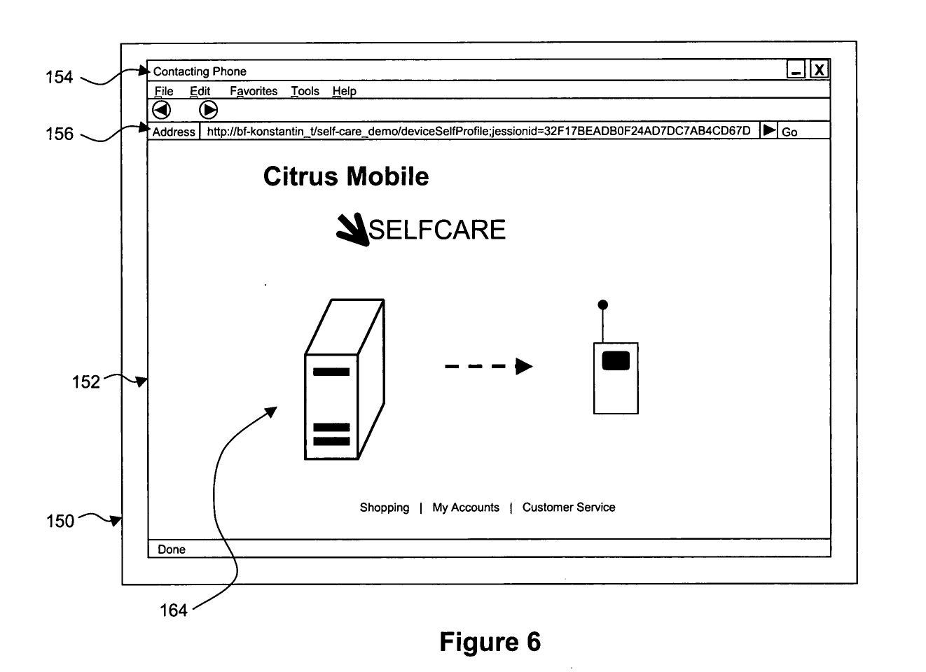

FIG. 6 illustrates a display screen 150 showing an exemplary web page 152 that may be displayed following entry of the subscriber directory number and activation of the “Submit” button 162 on the web page 152 of FIG. 5, in accordance with a representative embodiment of the present invention. As illustrated in FIG. 6, the web page 152 comprises a page name 154 “Checking My Phone” that identifies the new web page being viewed, and an Internet universal resource locator (URL) 156 that shows the new location now being accessed. Upon receiving the subscriber request and identity of the mobile handset, the customer care server 112 may send a request to the identified mobile handset (e.g., cell phone) using short message service (SMS) via the communication path 117, SMSC 118, wireless service provider 126 and base station 128, or using HTTP messaging via the communication path 119, IP gateway 120, wireless service provider 126 and base station 128. The above activity may be represented to the subscriber via a graphic 164 that may be animated to help the user to understand that actions are being taken to fulfill the request.

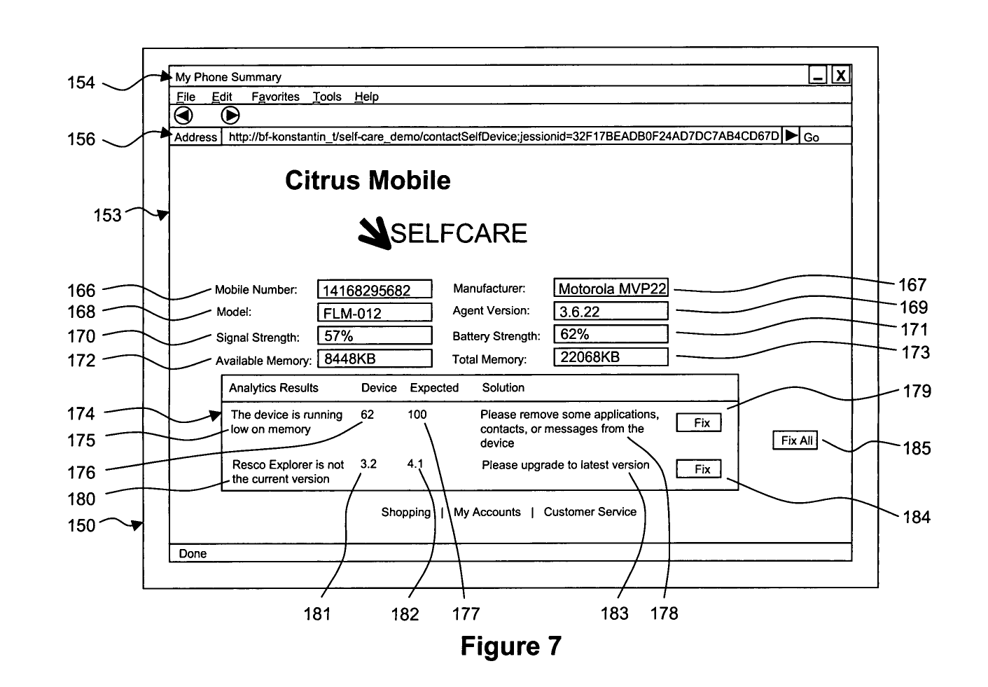

FIG. 7 shows a display screen 150 containing an exemplary web page 152 displaying device profile information such as that described above with respect to FIGS. 2, 3, and 4, following the retrieval of the device profile information from a subscriber mobile device such as, for example, the mobile device 132 of FIGS. 2, 3, and 4, in accordance with a representative embodiment of the present invention. The exemplary web page 152 of FIG. 7 comprises a page name 154 “My Phone Summary” that identifies the new web page being viewed, and an Internet universal resource locator (URL) 156 that shows the new location now being accessed. The device profile information shown on the web page 152 may comprise only a portion of the device profile retrieved from the mobile device, and may contain a number of items of information that are normally not accessible to a customer and that must normally be accessed by a customer service representative. The operator of the web portal (e.g., the wireless service provider 126 or a third party that provides customer care services for the subscribers of wireless service provider 126 (not shown)) may determine which items of the device profile information retrieved from the mobile device are made available to the subscriber.

As shown in the example web page 152 of FIG. 7, a representative embodiment of the present invention may provide device profile information including a mobile number field 166 that identifies the mobile device, a manufacturer field 167 that identifies the maker of the mobile device, and a mobile model field 168 that identifies the model of the mobile device. The exemplary device profile information web page 152 of FIG. 7 also includes an agent version field 169 that identifies the software/firmware version of a device agent such as, for example, the device agent 134 of FIG. 4, that may be resident in the mobile device. A signal strength field 170 may be presented to inform the user of the present signal strength received at either or both of the mobile device and the current serving base station. A battery strength indication 171 may be provided to help determine whether the battery is in need of charging, whether the battery is failing, or if sufficient battery capacity is available to allow updates of mobile device software or firmware, and provisioning of parameters and data. A representative embodiment of the present invention may also include an available memory field 172 and a total memory field 173, to allow the subscriber to be determine whether sufficient space is available for an update or upgrade, and whether additional memory may be added via, for example, a memory or subscriber identification module (SIM) card.

As discussed above, some items of information that are may be made available to a subscriber employing a representative embodiment of the present invention, may not have previously been available even to a customer service representative. The device agent of a representative embodiment of the present invention may have access to all of the contents of memory of the mobile device, and may provide such information to a customer care server such as, for example, the customer care server 112 of FIG. 4 upon request. Although a large number of items may be contained in the device profile information received by the customer care server 112, the actual information items displayed to a subscriber through a self-care interface such as that shown in FIG. 7 may be considerably less, and may be configurable by the wireless service provider that renders service to the subscriber.

As described previously, a customer care server in accordance with a representative embodiment of the present invention may employ a rule-based analytics engine such as, for example, the analytics engine 114 of FIG. 4 to analyze retrieved device profile information. The analytics engine may notify a subscriber of mobile device conditions that may be possible symptoms of current trouble, or that may cause future problems. The illustration of FIG. 7 shows an analysis portion 174 generated by an analytics engine. The analysis portion 174 contains an entry 175 in the results field that indicates the mobile device may be running low on memory. The rules used to arrive at such a conclusion may, for example, be defined by the wireless service provider 126 and/or by the manufacturer of the mobile service 132, as illustrated in FIG. 4. In the illustration of FIG. 7, the retrieved device profile information indicates that 62 units of memory 176 were found to be available, while the expected level of available memory 177 is shown to be 100 units. A recommended solution 178 to the variance from the applicable rule(s) indicates that removal of applications, contacts or messages is suggested. The subscriber may clock on the “Fix” button 179 to attempt a fix of the respective problem. The illustration of FIG. 7 also shows a second entry 180 in the results field that indicates that one of the software/firmware items in the mobile device is not the current version. The current device version is shown as version 3.2 181, and the expected version is shown as version 4.1 182. A suggestion 183 to resolve the variance from the rules requests that the version be upgraded to the latest version. The subscriber may follow the suggested resolution by clicking on “Fix” button 184. In this instance, a “fix” may comprise the automatic upgrading/updating of the existing software/firmware from the prior version (i.e., version 3.2) to the most recent version (i.e., version 4.1). The web page 152 shown in FIG. 7 also permits the subscriber to request that a fix of all problems be attempted by clicking on a “Fix All” button 185. A representative embodiment of the present invention permits a subscriber to avoid the lengthy delays that may occur when visiting the retail service locations of a wireless service provider, and the long queuing times and complex menus that are typically presented to subscribers calling for wireless problem resolution assistance.

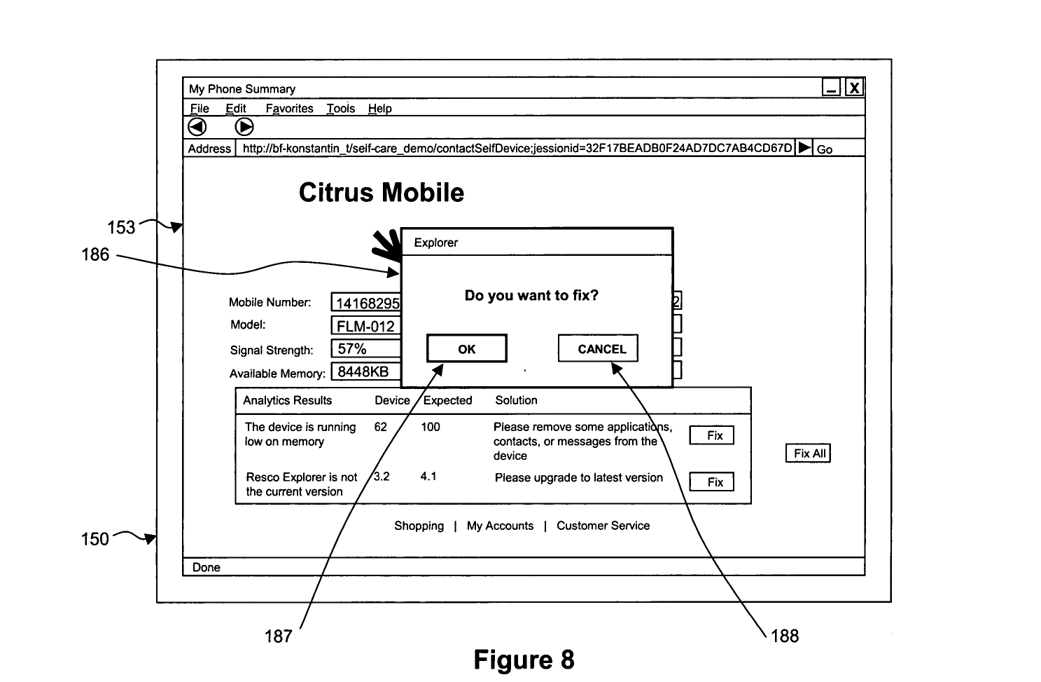

FIG. 8 illustrates a display screen 150 showing an exemplary web page 153 with a message box 186 that may be displayed to confirm a subscriber request to fix one of the problems shown in the analysis portion 174 of FIG. 7, in accordance with a representative embodiment of the present invention. The message box 186 may result, for example, from the subscriber clicking on the “Fix” button 184 shown in FIG. 7, to request that the out-of-date version of “Resco Explorer” be update to the latest version. The subscriber may confirm their intention of updating the software/firmware by clicking on the “OK” button 187, or cancel without updating by clicking on the “Cancel” button 188. Note that no interaction with customer service personnel is required to perform such a software/firmware update in a representative embodiment of the present invention. In a representative embodiment of the present invention, a customer care server such as, for example, the customer care server 112 of FIG. 4 may automatically manage retrieval of mobile device profile information, analysis of the retrieved device profile information in regard to a pre-determined set of rules, identification of any problems or anomalies, verification of the identity of the subscriber and the mobile device, and the updating of any software and/or firmware, or device parameters and data.

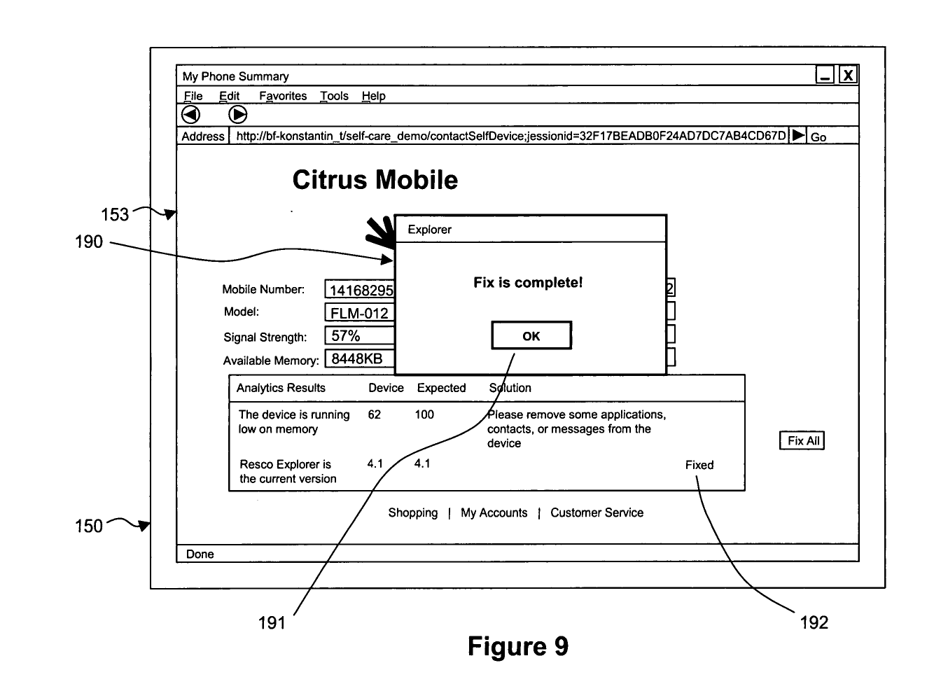

FIG. 9 illustrates a display screen 150 showing an exemplary web page 153 comprising a message box 190 that may be displayed to confirm the successful completion of an action such as that requested with respect to FIG. 8, in accordance with a representative embodiment of the present invention. As is shown in the illustration of FIG. 9, the message box 190 indicates that the action requested using the “Fix” button 184 of FIG. 8 has changed the status of the “Resco Explorer” application to indicate “Fixed” 192. Although this example has illustrated the update of firmware or software based upon retrieval of device profile information by a customer care server in accordance with a representative embodiment of the present invention, this does not represent a specific limitation of the present invention. As described above, a device profile such as the device profile information 135 of FIGS. 2, 3 and 4 may comprise a large variety of items of information about the mobile device 132. This permits an analytics engine such as that shown as analytics engine 114 of FIG. 4 to compare each retrieved information item to an appropriate set of rules that define acceptable values for the information item based upon other parameters for the subscriber, the mobile device in use, the set of services to which the subscriber is entitled, and a number of other factors.

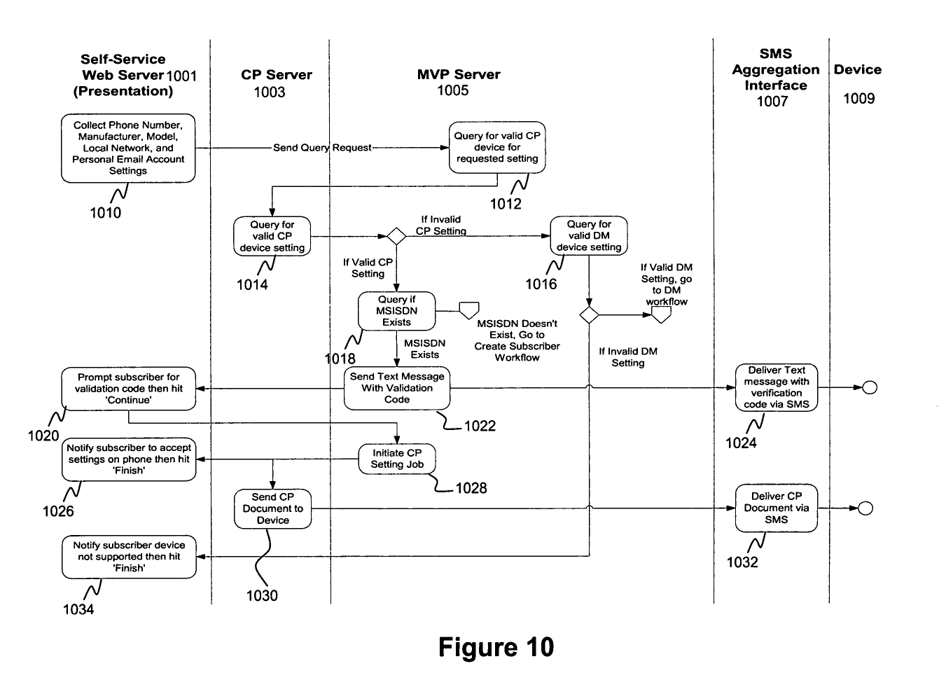

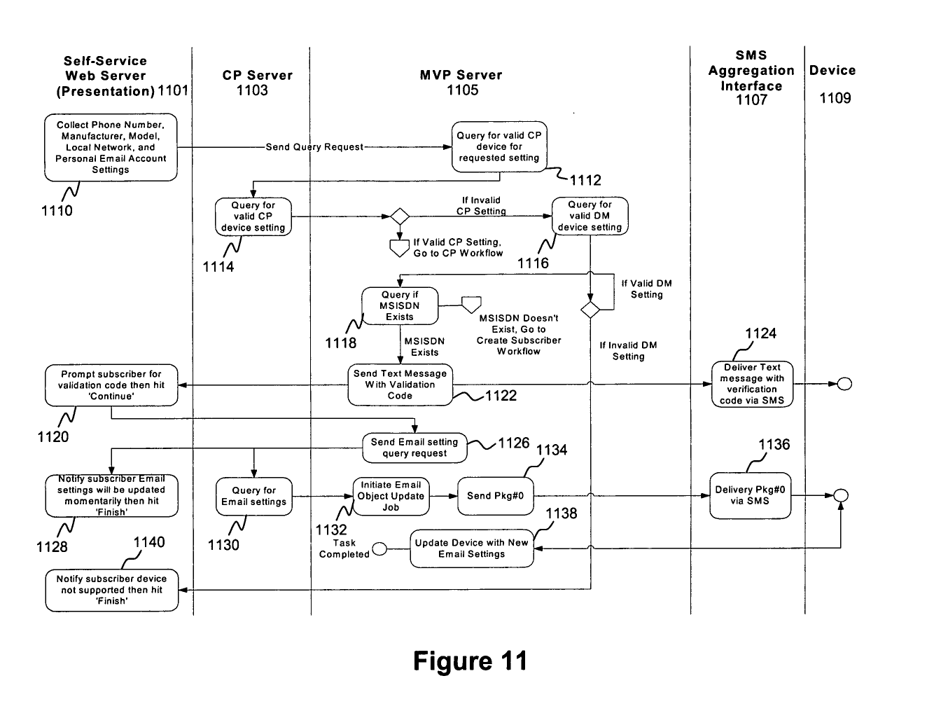

FIG. 10 shows a workflow diagram for an exemplary self-care client provisioning settings process for an electronic device such as, for example, the mobile device 132 shown in FIGS. 2, 3 and 4, in accordance with a representative embodiment of the present invention. FIG. 10 illustrates the activities and the messaging exchanged between a self-care web server 1001, a client provisioning (CP) server 1003, a device management (DM) server 1005, a short message service (SMS) aggregation interface 1007, and a mobile device 1009. The process of FIG. 10 begins when a subscriber accesses the self-care or self-service web server 1001 such as, for example, the customer care server 112 of FIG. 4. As shown in FIG. 5, the self-care web server 1001 may collect information such as, for example, a phone number, manufacturer, model, local network, and personal email account settings from the subscriber (block 1010). The self-care web server 1001 may send a query request to the device management (DM) server 1005 that may correspond to, for example, the DM server 105 of FIG. 1. An example of a suitable DM server is the Mobile Variance Platform (MVP) server available from Bitfone Corporation. The DM server 1005 (e.g., DM server 105) may query the client provisioning CP server 1003 that may correspond to, for example, the provisioning server 104 of FIG. 1, for a valid CP device for the requested settings (block 1012). The CP server 1003 may then respond to the DM server 1005 (block 1014), and the DM server 1005 may determine whether a valid CP setting is available. If it is determined that the CP setting is invalid, the DM server 1005 may query for a valid DM setting (block 1016). If it is determined that the DM setting is valid, a DM settings workflow process such as that shown in FIG. 11, described below, may be activated. If it is determined that the DM setting is invalid, the DM server 1005 may signal the self-care web server 1001 (e.g., a customer care server having a web interface such a customer care server 112 of FIG. 4) to notify the subscriber that the mobile device 1009 is not supported (block 1034).

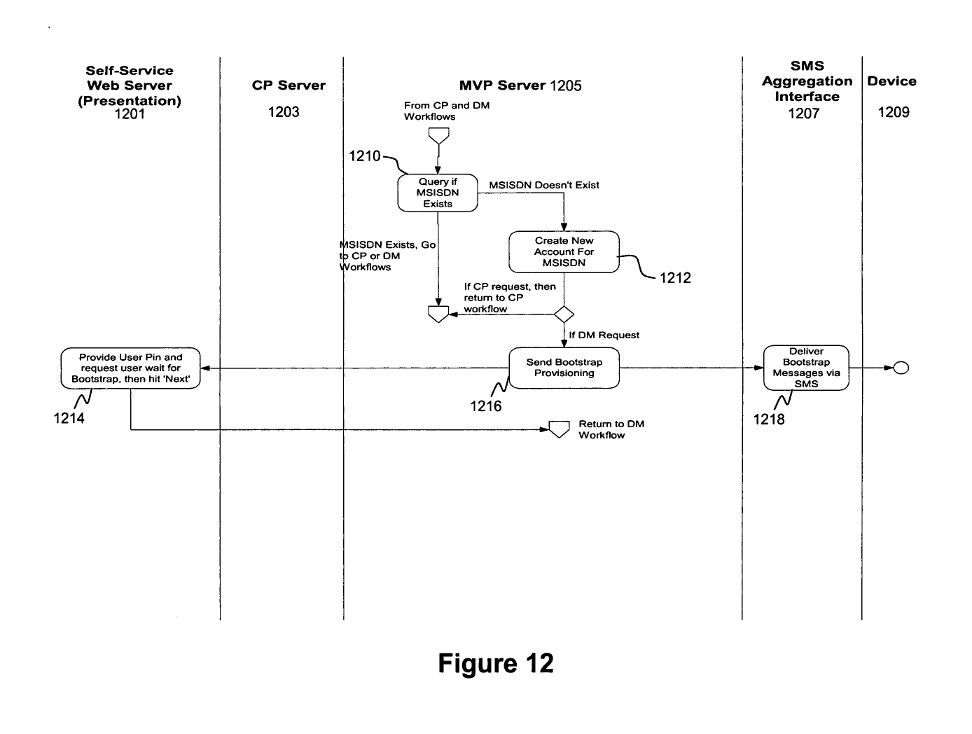

If it is determined that the CP setting is valid, the DM server 1005 may query whether a mobile station ISDN (MSISDN) exists (block 1018). If it is determined that an MSISDN exists, the DM server 1005 may send a text message to the self-care web server 1001 to prompt the subscriber for a validation code (block 1020). When the user enters and signals to continue, the DM server 1005 may forward the received validation code to a short message service aggregation interface 1007 (block 1022), which may then deliver a text message with the verification code to the mobile device 1009 via SMS (block 1024). At the same time, the DM server 1005 may initiate a CP settings job (block 1028), that signals the CP server 1003 to send a CP settings document to the mobile device 1009 (block 1030) via the SMS aggregation interface 1007. The DM server 1005 may also message the self-care web server 1001 to notify the subscriber to accept the settings on the mobile device 1009 and then hit “Finish”. If, however, it is determined that the MSISDN does not exist (block 1018), the process of FIG. 10 may activate a new account/subscriber creation workflow process such as that shown in FIG. 12, described below, for example.

FIG. 11 shows a work flow diagram for an exemplary self-care process of updating device management settings for a device such as, for example, the mobile device 132 shown in FIGS. 2, 3 and 4, in accordance with a representative embodiment of the present invention. FIG. 11 illustrates the activities and the messaging exchanged between a self-care web server 1101, a client provisioning (CP) server 1103, a device management (DM) server 1105, a short message service (SMS) aggregation interface 1107, and a mobile device 1109. The process of FIG. 11 begins when a subscriber accesses the self-care or self-service web server 1101 such as, for example, the customer care server 112 of FIG. 4. As shown in FIG. 5, the self-care web server 1101 may collect information such as, for example, a phone number, manufacturer, model, local network, and personal email account settings from the subscriber (block 1110). The self-care web server 1101 may send a query request to the device management (DM) server 1105 that may correspond to, for example, the DM server 105 of FIG. 1. An example of a suitable DM server is the Mobile Variance Platform (MVP) server available from Bitfone Corporation. The DM server 1105 (e.g., DM server 105) may query the client provisioning CP server 1103 that may correspond to, for example, the provisioning server 104 of FIG. 1, for a valid CP device for the requested settings (block 1112). The CP server 1103 may then respond to the DM server 1105 (block 1114), and the DM server 1105 may determine whether a valid CP setting is available. If it is determined that the CP setting is invalid, the DM server 1105 may query for a valid DM setting (block 1116). If it is determined that the DM setting is invalid, the DM server 1105 may signal the self-care web server 1101 (e.g., a customer care server having a web interface such a customer care server 112 of FIG. 4) to notify the subscriber that the mobile device 1109 is not supported (block 1140). If it is determined that the CP setting is valid, the DM server 1105 may activate a CP setting workflow process such as that described above with respect to FIG. 10, for example.

If it is determined that the DM setting is valid, the DM server 1105 may query whether a mobile station ISDN (MSISDN) exists (block 1118). If it is determined that the MSISDN does not exist (block 1118), the process of FIG. 11 may activate a new account/subscriber creation workflow process such as that shown in FIG. 12, described below, for example. If, however, it is determined that an MSISDN does exist, the DM server 1105 may send a text message to the self-care web server 1101 to prompt the subscriber for a validation code (block 1120). When the user enters and signals to continue, the DM server 1105 may forward the received validation code to a short message service aggregation interface 1107 (block 1122), which may then deliver a text message with the verification code to the mobile device 1109 via SMS (block 1124). At the same time, the DM server 1105 may send an email setting query request to the self-care web server 1101 (block 1126), and the self-care web server 1101 may notify the subscriber that email settings will be updated (block 1128). The DM server 1105 may also send the email settings query request to the CP server 1103 (block 1130). The CP server 1103 may then send a response to the DM server 1105 that initiates an email object update setting job (block 1132), and causes the sending of a package of information containing an object update request (e.g., Pkg #0) to the SMS aggregation interface 1107 (block 1134). The SMS aggregation interface 1107 then delivers the package with the object update request (i.e., Pkg #0) to the mobile device 1109 (block 1136) via SMS. The mobile device 1109 may then exchange updated email settings with the DM server 1105 via a communication path that may employ, for example, the HTTP messaging protocol (block 1138). The update task updating the email setting of the mobile device 1109 is then competed.

FIG. 12 shows a flow diagram for an exemplary self-care process of performing new account registration for a device such as, for example, the mobile device 132 shown in FIGS. 2, 3 and 4, in accordance with a representative embodiment of the present invention. FIG. 12 illustrates the activities and the messaging exchanged between a self-care web server 1201, a device management (DM) server 1205, a short message service (SMS) aggregation interface 1207, and a mobile device 1209. The new account registration process of FIG. 12 may be activated from either the CP settings process of FIG. 10, or the DM settings process of FIG. 11, when an MSISDN for the mobile device 1009, 1109 does not exist. Upon activation of the new account registration process of FIG. 12, the DM server 1205 that may correspond to, for example, the DM server 116 of FIG. 1, may query to determine whether the MSISDN exists (block 1210). If the MSISDN of interest does in fact exist, the new account registration processor of FIG. 12 may proceed, as appropriate, to the CP settings workflow of FIG. 10, or the DM settings workflow of FIG. 11. If however, the MSISDN does not exist (block 1210), the DM server 1205 may create a new account for the MSISDN (block 1212). Following creation of the new account (block 1212), the DM server 1205 determines whether the entry to the new account creation process originated in the DM setting process of FIG. 11. If it did not, the DM server 1205 may send a bootstrap provisioning message to the self-care web server 1201 to request user authorization (e.g., a personal identification number (PIN)) (block 1216). The DM server may also send a bootstrap message to the SMS aggregation interface 1207 (block 1216). The SMS aggregation interface 1207 may then deliver the bootstrap provisioning message to the mobile device 1209. The receipt of the bootstrap provisioning message by the self-care web server 1201 may cause a notification to the subscriber to wait for completion of the bootstrap activity in the mobile device. Upon completion of the bootstrap, the user may be requested to press a “Next” key to complete the new account registration process (block 1214), and the DM server may then proceed to the CP settings workflow of FIG. 10, or the DM settings workflow of FIG. 11.

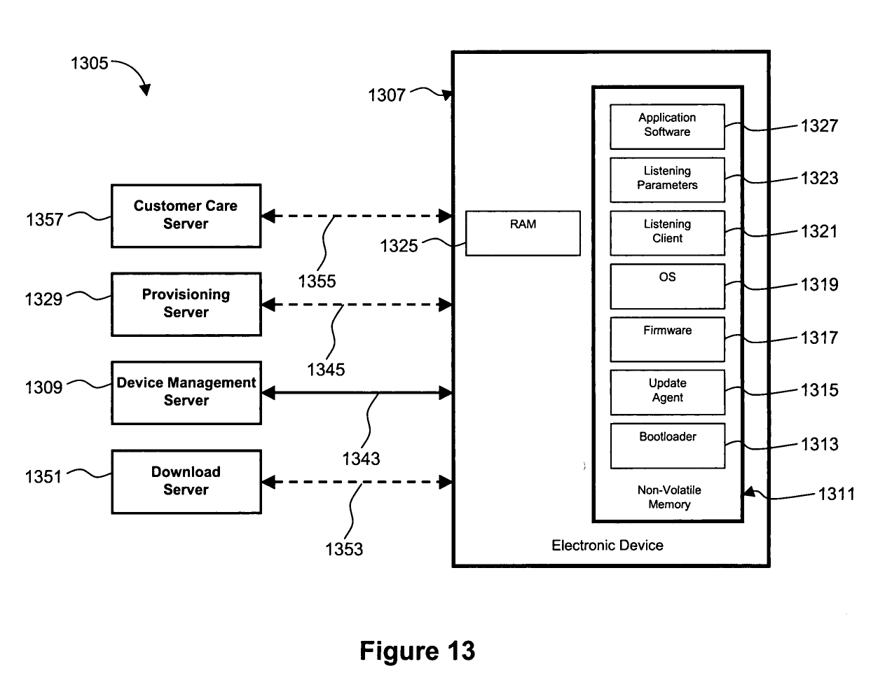

FIG. 13 is a perspective block diagram of a network 1305 for mass distribution of firmware and software updates that comprises a device management (DM) server 1309, an electronic device 1307 and a provisioning server 1329, in accordance with a representative embodiment of the present invention. The provisioning server 1329 may also be referred to herein as a “broadcast server”. The electronic device 1307 may update application software 1327, an operating system (OS) 1319, or firmware 1317 in the electronic device 1307 employing an update package delivered by the provisioning server 1329. The electronic device 1307 may apply updates using one or more update agents 1315 that are each capable of processing update packages or subsets thereof.

The network 1305 also comprises a download server 1353 that may be used to download firmware and software updates. A customer care server 1357 may enable access to the information in the electronic device 1307 by customer care/service representatives (CSR) in communication with the customer care server 1307. A provisioning server 1329 facilitates communication of provisioning information, over the air (OTA), to the electronic device 1307.

The electronic device 1307 may comprises a listening client 1321 that is capable of listening to a broadcast channel from the provisioning server 1329, and downloading an update package broadcast by the provisioning server 1329. In a representative embodiment of the present invention, an update package may comprise a set instructions executable by the electronic device 1307 that, when executed, produce an updated version of code or data from the existing code or data in the electronic device 1307. The listening client 1321 may employ listening parameters 1323 that are set by the DM server 1309 to facilitate the download from the provisioning server 1329 of update packages and related information.

In this manner, a representative embodiment of the present invention such as the network 1305 supports mass distribution of firmware and software updates using “broadcast” methods that may be employed by the provisioning server 1329. The network 1305 may employ a device management protocol such as, for example, the Open Mobile Alliance (OMA) device management (DM) protocol, that may be supported by the DM server 1309. Other protocols may alternatively be used for device discovery. The OMA-DM server 1309 may use an OMS-DM message comprising a ‘Replace’ command to set ‘listening parameter(s)’ 1323, that may be used for update package download. An update package in a representative embodiment of the present invention may comprise, among other things, a set of instructions executable by the electronic device 1307 for converting existing versions of application software 1327, OS 1319, firmware 1317, the update agent 1315, and/or the boot loader 1311, to updated versions in the electronic device 1307. Using the ‘listening parameter(s)’ 1323, the ‘listing client’ 1321 on the electronic device 1307 may accept or reject meta-data packets that may be broadcast to all electronic devices 1307 using over-the-air (OTA) (i.e., wireless) means.

In one representative embodiment of the present invention, the specific ‘listening parameter(s)’ 1323 provided by the DM server 1309 may be used by the listening client 1321 to determine whether or not a broadcast packet is useful or not for that specific electronic device 1307. The listening client 1321 in the electronic device 1307 may then receive one packet at a time from a broadcast communication means and re-assembles the packets using meta-data wrappers of each packet, in order to complete the download.

A method of downloading firmware and software updates using a broadcast means, such as the method of the present invention described herein, is useful and desirable for high-volume mass updates of electronic devices such as the electronic device 1307, for example, where the same data needs to be transmitted to many devices. Such a method reduces network congestion by broadcasting information once, and allows all ‘provisioned’ devices such as the electronic device 1307 to accept the transmitted information. This method is especially effective for performing background downloads during off-peak hours to reduce bandwidth costs.

In a representative embodiment of the present invention, the network 1305 for mass broadcast of update packages to electronic devices makes it possible to efficiently broadcast update packages for firmware and software updates. The provisioning server 1329 in the network 1305 employs broadcast means to broadcast update packages. The electronic device 1307 capable of receiving these broadcast update packages comprises the listening client 1321, that is capable of listening to broadcast update packages, such as over a broadcast channel, and downloading an update package broadcast by the broadcast server 1329. The listening client 1321 of a representative embodiment of the present invention makes use of listening parameters 1323 that may be set by the DM server 1309, in order to facilitate the download from the broadcast server 1329.

In one representative embodiment of the present invention, the broadcast means employed by the provisioning server 1329 and the corresponding listening client 1321 may be a multicast Internet protocol (IP) network.

In another representative embodiment of the present invention, a broadcast server such as the provisioning server 1329 of FIG. 13 may employ a specific IP address that typically used to indicate that an IP packet is an IP broadcast packet. The listening client 1321 may be capable of treating these packets as IP broadcast packets.

In a representative embodiment of the present invention, the broadcast means employed by the provisioning server 1329 may be an IP multicast mechanism. The network 1305 may handle the mapping of IP multicast addresses to link-layer addresses that may have been specified through other means.

In a representative embodiment of the present invention, the provisioning server 1329 may support directed broadcast, wherein a packet is sent to a specific network (or sub-network) or series of networks, and flood-broadcast. When using flood broadcasting, a packet may be sent to every connected network (or sub-network).

In a representative embodiment of the present invention, the provisioning server 1329 may support provisioning of devices using client provisioning (CP) means and OMA-DM bootstrap provisioning means, and may employ other legacy means.

In a representative embodiment of the present invention, the update agent/client 1315 in the electronic device 1307 may be capable of updating the firmware and/or software in the electronic device 1307 using update packages, that are retrieved based on a parameters set. The electronic device 1307 may ensure that the update packages received are not corrupted, and may store them (e.g., in non-volatile memory 1311) for subsequent processing.

In a representative embodiment of the present invention, the provisioning server 129 may employ one of several available broadcast means to communicate an update package to a plurality of electronic devices 1307 including SMS, HTTP, and other protocols.

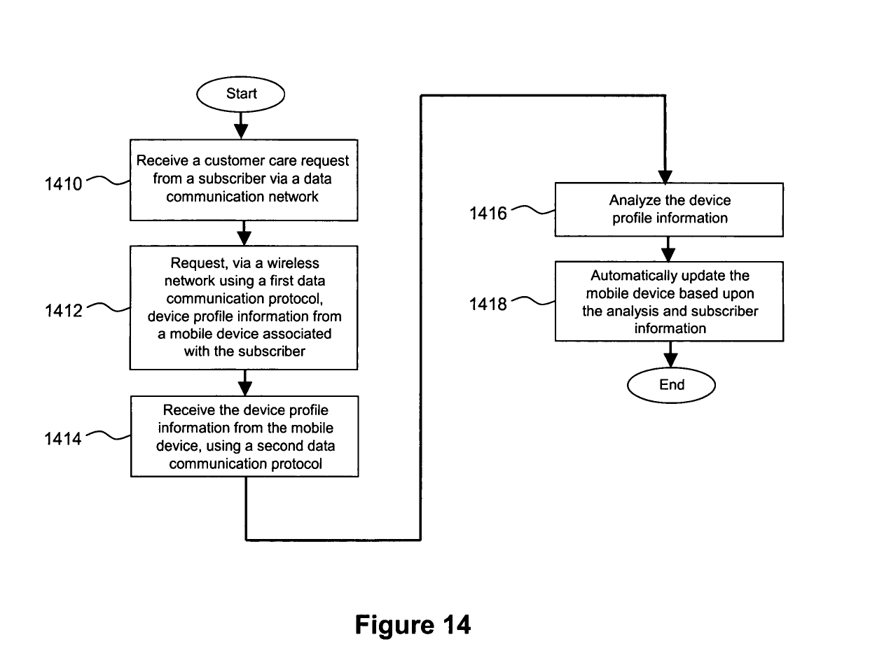

FIG. 14 is a flowchart of an exemplary method of providing customer care for a subscriber of a wireless communication network such as, for example, the wireless communication network 100 of FIG. 4, in accordance with a representative embodiment of the present invention. The method of FIG. 14 may be practiced, for example, in a customer care server such as, for example, the customer care server 112 of FIG. 4. The method of FIG. 14 begins when a customer care server (e.g., 112 of FIG. 4) receives a customer care request from a subscriber via a data network (block 1410). As shown in FIG. 4, the subscriber issuing the request may be using a conventional web browser represented by wireless subscriber browser 130. A suitable web browser includes the Internet Explorer browser from Microsoft Corporation, for example. The subscriber may use the browser to access a web portal via a packet network 127. The web portal may be supported by a customer care server such as the customer care server 112. The customer care server (e.g., 112 of FIG. 4) may then request, via a wireless network using a first data communication protocol, device profile information from a mobile device associated with the subscriber (block 1412). The wireless network, represented in FIG. 4 as wireless service provider 126 and base station 128, may comprise a cellular, wireless wide area network, or paging network, for example.

In a representative embodiment of the present invention, the electronic device (e.g., 132 of FIG. 4) may then respond and transmit the requested device profile information. The customer care server may then receive the device profile information from the mobile device, using a second data communication protocol (block 1414). For example, the request may be sent to the mobile device using SMS, and the response from the mobile device may be received using HTTP. A representative embodiment of the present invention may comprise both an SMS center (SMSC) and an IP gatway, to support such messaging. Such an arrangement is illustrated in FIG. 4.

Next, the customer care server may analyze the device profile information (block 1416). This analysis may involve the use of a rules-based analytics engine such as the analytics engine 114 described above with respect to FIG. 4. Such analysis may determine that parameters in the device profile that are related to service from the wireless service provider have been changed incorrectly, or are currently inappropriate for the subscriber. The analysis may also determine that various software or firmware code in the mobile device is out of date, and should be updated. In some representative embodiments of the present invention, the request may cause the user of the mobile device to be prompted, to make them aware of the activity, and to request their approval for the actions taken.

In a representative embodiment of the present invention, a customer care server such as the customer care server 112 of FIG. 4 may send messaging to the mobile device to automatically perform an update of the mobile device (block 1418). This may include updating device profile information and software and/or firmware. In some representative embodiments of the present invention, when such an update is confirmed to have been completed, the results of the updating operations may be provided to the subscriber via the web portal supported by the customer care server.

Aspects of the present invention may be seen in a method of providing customer care for a subscriber of a wireless communication network. Such a method may comprise receiving a customer care request from the subscriber via a data communication network, and requesting, via the wireless communication network using a first data communication protocol, device profile information from a mobile device associated with the subscriber. The method may comprise receiving the device profile information from the mobile device, using a second data communication protocol. The method may also comprise analyzing the device profile information, and automatically updating the mobile device based upon the analysis and subscriber information. The communication network may comprise a public wireless network, and the public wireless network may comprise a cellular network. The data communication network may comprise a public network, and the data communication network may comprise the Internet.

In a representative embodiment of the present invention, the device profile information may comprise mobile device parameters enabling service in the wireless communication network. The device profile information may also comprise information representative of at least one of the following: memory usage, a battery status, and operating parameters of an active wireless link. The first data communication protocol may comprise a short message service (SMS) protocol, and the second data communication protocol may comprise a hypertext transport protocol (HTTP). The analysis may employ a set of rules to determine the updates to the device profile information. The updating may transform, in memory of the mobile device, portions of an existing code version to produce an updated code version. The memory may comprise non-volatile memory. The conversion may employ updating information received wirelessly by the mobile device, and the updating information may comprise a set of instructions executable by the mobile device to convert the existing code version to the updated code version. The method may also comprise notifying the subscriber of results of the customer care request, via the data communication network, and may comprise storing a record of the subscriber request. In a representative embodiment of the present invention, the first and second data communication protocols may be the same protocol, and the first and second data communication protocols may be compliant with an Open Mobile Alliance (OMA) device management (DM) protocol.

Additional aspects of the present invention may be observed in a communication device comprising at least one memory comprising device profile information and an existing version of executable operating code for the communication device. The device may also comprise a first code portion resident in the at least one memory. The first code portion may process a request for device profile information. The request may be from at least one remote server received wirelessly from a wireless communication network using a first data communication protocol. The device may also comprise a second code portion resident in the at least one memory. The second code portion may wirelessly transmit to the at least one remote server the requested device profile information using a second communication protocol. At least a portion of the device profile information in the communication device may be updated following analysis of the device profile information at the at least one remote server. In various representative embodiments of the present invention, device profile information may comprise at least one of the following: communication parameters enabling service in the wireless communication network, application configuration settings, and device capabilities. The first data communication protocol may comprise a short message service (SMS) protocol, and the second data communication protocol may comprise a hypertext transport protocol (HTTP). The at least one remote server may originate the request based upon a subscriber request.

Yet other aspects of the present invention may be found in a customer care system comprising at least one server for receiving, via a data communication network, a request from a subscriber of a wireless communication network. The system may comprise profiler code resident on the at least one server, the profiler code functioning to cause retrieval of device profile information from a wireless mobile device associated with the subscriber. The system may also comprise analysis code resident on the at least one server for analyzing the retrieved device profile information. The system may also comprise device management code resident on the at least one server, the device management code causing automatic updating of the wireless mobile device based upon the analysis. The data communication network may comprise a packet network, and the packet network may comprise the Internet. The wireless communication network may comprise one of the following: a cellular network and a paging network, and the wireless mobile device may comprise one of the following: a cellular phone, a pager, and a personal digital assistant.

In a representative embodiment of the present invention, the profiler code may employ a short message service (SMS) protocol to request device profile information from the wireless mobile device. The device management code may communicate with the wireless mobile device using an Open Mobile Alliance compliant device management protocol. The subscriber may be notified of the results of the analysis via the data communication network. The device profile information may comprise mobile device parameters enabling service in the wireless communication network, and the device profile information may comprise information representative of at least one of the following: memory usage, a battery status, and operating parameters of an active wireless link.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of providing customer care for a subscriber of a wireless communication network, the method comprising:
receiving a customer care request from the subscriber via a data communication network;
requesting, via the wireless communication network using a first data communication protocol, device profile information from a mobile device associated with the subscriber;
receiving the device profile information from the mobile device, using a second data communication protocol;
analyzing the device profile information; and
automatically updating the mobile device based upon the analysis and subscriber information.

2. The method according to claim 1, wherein the communication network comprises a public wireless network.

3. The method according to claim 2, wherein the public wireless network comprises a cellular network.

4. The method according to claim 1, wherein the data communication network comprises a public network.

5. The method according to claim 4, wherein the data communication network comprises the Internet.

6. The method according to claim 1, wherein the device profile information comprises mobile device parameters enabling service in the wireless communication network.

7. The method according to claim 1, wherein the device profile information comprises information representative of at least one of the following: memory usage, a battery status, and operating parameters of an active wireless link.

8. The method according to claim 1, wherein the first data communication protocol comprises a short message service (SMS) protocol.

9. The method according to claim 1, wherein the second data communication protocol comprises a hypertext transport protocol (HTTP).

10. The method according to claim 1, wherein the analysis employs a set of rules to determine the updates to the device profile information.

11. The method according to claim 1, wherein the updating transforms, in memory of the mobile device, portions of an existing code version to produce an updated code version.

12. The method according to claim 11, wherein the memory comprises non-volatile memory.

13. The method according to claim 11 wherein the conversion employs updating information received wirelessly by the mobile device, the updating information comprising a set of instructions executable by the mobile device to convert the existing code version to the updated code version.

14. The method according to claim 1, further comprising:
notifying the subscriber of results of the customer care request, via the data communication network.

15. The method according to claim 1, further comprising:
storing a record of the subscriber request.

16. The method according to claim 1, wherein the first and second data communication protocols are the same protocol.

17. The method according to claim 1, wherein the first and second data communication protocols are compliant with an Open Mobile Alliance (OMA) device management (DM) protocol.

18. A communication device comprising:
at least one memory comprising device profile information and an existing version of executable operating code for the communication device;
a first code portion resident in the at least one memory, the first code portion for processing a request for device profile information, the request from at least one remote server received wirelessly from a wireless communication network using a first data communication protocol;
a second code portion resident in the at least one memory, the second code portion for wirelessly transmitting to the at least one remote server the requested device profile information using a second communication protocol; and
wherein at least a portion of the device profile information in the communication device is updated following analysis of the device profile information at the at least one remote server.

19. The device according to claim 18, wherein device profile information comprises at least one of the following: communication parameters enabling service in the wireless communication network, application configuration settings, and device capabilities.

20. The device according to claim 18, wherein the first data communication protocol comprises a short message service (SMS) protocol.

21. The device according to claim 18, wherein the second data communication protocol comprises a hypertext transport protocol (HTTP).

22. The device according to claim 18, wherein the at least one remote server originates the request based upon a subscriber request.

23. A customer care system comprising:
at least one server for receiving, via a data communication network, a request from a subscriber of a wireless communication network;
profiler code resident on the at least one server, the profiler code functioning to cause retrieval of device profile information from a wireless mobile device associated with the subscriber;
analysis code resident on the at least one server for analyzing the retrieved device profile information; and
device management code resident on the at least one server, the device management code causing automatic updating of the wireless mobile device based upon the analysis.

24. The system according to claim 23, wherein the data communication network comprises a packet network.

25. The system according to claim 23, wherein the packet network comprises the Internet.

26. The system according to claim 23 wherein the wireless communication network comprises one of the following: a cellular network and a paging network.

27. The system according to claim 23, wherein the wireless mobile device comprises one of the following: a cellular phone, a pager, and a personal digital assistant.

28. The system according to claim 23, wherein the profiler employs a short message service (SMS) protocol to request device profile information from the wireless mobile device.

29. The system according to claim 23, wherein the device management code communicates with the wireless mobile device using an Open Mobile Alliance compliant device management protocol.

30. The system according to claim 23, wherein the subscriber is notified of the results of the analysis via the data communication network.

31. The system according to claim 23, wherein device profile information comprises mobile device parameters enabling service in the wireless communication network.

32. The system according to claim 23, wherein the device profile information comprises information representative of at least one of the following: memory usage, a battery status, and operating parameters of an active wireless link.
